(19) United States
(12) Patent Application Publication
(10) Pub. No.: US 2018/0014711 A1
(43) Pub. Date: Jan. 18, 2018

(54) COMPOSTABLE AND BIODEGRADABLE WET WIPE PAD FOR CLEANING MOP HEADS

(71) Applicant: Naturezway, Inc., City of Commerce, CA (US)

(72) Inventor: Habib Rostami, Irine, CA (US)

(73) Assignee: Naturezway, Inc., City of Commerce, CA (US)

(21) Appl. No.: 15/653,162

(22) Filed: Jul. 18, 2017

Related U.S. Application Data
(60) Provisional application No. 62/363,820, filed on Jul. 18, 2016.

(51) Int. Cl. A47L 13/24; B32B 23/08; B32B 27/36; B29C 65/08; B29L 31/00

(52) U.S. Cl. CPC A47L 13/24; B32B 27/36; B29C 65/08; B32B 23/08; B29L 2031/7406

(57) ABSTRACT

A wet wipe pad designed to be connected or attached to floor mop heads or other cleaning tool handle that utilize a hook-and-loop mechanism for attaching the wipe pad thereto. The wipe pad can be made of multi layers of material that may include a cleaning layer ultrasonically welded to an attachment layer having an absorption layer disposed between the cleaning layer and the attachment layer. Alternatively, the wipe pad can be made from a single layer of material that can attach on one side thereof to the mop head or other cleaning tool handle, which also provides a cleaning surface on the other side of the single layer of material. The wipe pad of the invention may also be constructed from two layers of material that include a cleaning layer ultrasonically welded to an attachment layer. Regardless of the number of layers used in the wipe pad of the invention, the wipe pad is configured with at least one linking ribbon or tape strip of non-looped straight-line fibers extending along the length of the attachment layer and which forms the means or mechanism for releasably securing to “hooks” disposed on the mop head. The wipe pad, including its layer(s) and the linking ribbon or tape strip is constructed of materials that are compostable and biodegradable, making it an environmentally friendly product.

### CROSS-REFERENCE TO RELATED APPLICATION

This application claims the benefit of U.S. Provisional Application Ser. No. 62/363,820 filed Jul. 18, 2016, the content of which is incorporated herein by reference.

### BACKGROUND OF THE INVENTION

The present invention relates to the field of cleaning devices. This invention generally relates to replaceable wipe pads for use with floor cleaning mop heads or other cleaning tool handles in wet applications, and specifically to replaceable compostable/biodegradable wet wipe pads that attach to mop heads that utilize a ‘hook-and-loop’ mechanism for attaching the wipe pad to the mop head or other cleaning tool handle.

As shown in FIGS. 1 and 2, various floor cleaning mops currently exist that have a mop head 100 that incorporates a traditional hook-and-loop fastening mechanism (for example, as manufactured under the brand name VELCRO by Velcro USA, Inc. of Manchester, N.H.) embodied in one or more lineal (linear) strips 122, 124 or other attachment configurations (for example, round “dots” or squares) for allowing removable wipe pads 200 to be attached from a first end 130 to a second end 140 along the body 110 of the mop head having a handle portion 150. Such wipe pads may include a suitable surface 210 for retaining one or more traditional hook-and-loop (touch fastener) strips 222, 224 extending from a first end 330 to a second end 340 along the surface of the wipe pad for attachment onto the mop head. As the wipe pad is used and becomes dirty, the wipe pad can be removed, thrown away (discarded), and then replaced with a new, clean wipe pad.

In such existing designs, the physical construction of the removable wipe pad 200 is such that multiple layers of the surface material 210, typically made of polyester (or P.E.), are sewn or glued together to assemble the wipe pad. However, although these existing wipe pads may be able to attach to the mop head 10 via the hook-and-loop mechanisms in a dry environment, one of the drawbacks or shortcomings of the known design is that the wipe pad strips 222, 224 having the traditional “loops” are not able to attach well (or satisfactorily remain attached) to the mop head strips 122, 124 having the “hooks” in situations when the mop is used to clean wet floors and the wipe pad gets wet. As such, when existing wipe pads are used to clean wet floor or are used in other wet application, either the strips on the wipe pad do not attach well to the strips on the mop head or the strips on the wipe pad become detached and fall off the mop head.

Another known cleaning device has a cleaning pad support platen defining a support cleaning surface region that is arranged to releasably receive and secure a conventional cleaning pad using hook-and-loop fasteners on the platen. The cleaning pad includes a relatively non-abrasive cleaning surface. A scrub device with a relatively more abrasive surface is attached to the cleaning pad. One or more such scrub devices may be attached to the same cleaning pad surface to cover part or the entire cleaning pad surface. The abrasive scrub devices may have different dimensions to cover different areas of the cleaning pad's non-abrasive surface to provide enhanced scrubbing action as desired. The abrasive scrub devices may be provided with different abrasion surfaces having different abrasive values and may be removed to expose the full non-abrasive cleaning surface for non-abrasive cleaning. Also known are hand held devices having multiple layer scrubbing pads for attaching to a rigid hand held handle. Such devices are unduly expensive and difficult to manufacture as a disposable wipe pad.

Another design is disclosed in this inventor's U.S. application Ser. No. 14/160,295, contents of which are incorporated herein by reference. Therein is disclosed a removable wipe pad design that uses non-looped straight-line strips of fibers as a linking ribbon/tape to attach to the “hook” elements on the mop head, and as such, provides a removable wipe pad that has good liquid absorbency and is able to be used more effectively in wet mopping applications without the wipe pad falling off the mop head or coming loose from the mop head where the layers of material for the wipe pad are attached together by an ultrasonic welding method.

However, these existing disposable and removable wipe pads are not very suitable for wet applications (except for the invention disclosed in U.S. application Ser. No. 14/160,295), and they are not compostable and biodegradable. As a result, they are not environmentally friendly, as one would desire.

In view of the foregoing, there is a need for, and what was heretofore unavailable, a wipe pad that is economically manufactured, simple to use and can easily and removably attach itself to the mop head or other cleaning tool handle using a ‘hook-and-loop’ mechanism without sewing or gluing, wherein the wipe pad has good liquid absorbency and is able to be used in wet mopping applications without the wipe pad falling off the mop head or coming loose from the mop head, while the wipe pad is also compostable and biodegradable. The present invention fulfills these and other needs.

### SUMMARY OF THE INVENTION

Briefly, and in general terms, the present invention is directed to replaceable wipe pads for use with floor cleaning mop heads or other cleaning tool with a handle in wet applications that utilize a ‘hook-and-loop’ mechanism for attaching the wipe pad to the mop head or cleaning tool with a handle. The wet wipe pad of the present invention is designed to connect or attach to floor mop heads that utilize a hook-and-loop mechanism for attaching the wipe pad to the mop head, such as the existing mop head shown in FIG. 1.

The composition of materials used in manufacturing the wipe pad of the present invention is designed to absorb and hold liquid (for example, water) while performing the function of cleaning or mopping of floors and other surfaces. The physical construction of the wipe pad is designed to use no glue or sewing for assembling of the pad. Rather, the wipe pad of the present invention may be assembled and manufactured using ultrasound, embossing and pressing equipment that are known to those skilled in the art of designing such cleaning devices and similar multi-layered products. In addition, the wipe pad may include multiple logo-embossed areas formed by ultrasound pressing to provide for additional connectivity of the various layers of the wipe pad together. Furthermore, the materials and design used for the wipe pad of the present invention render it compostable and biodegradable.

The wipe pad of the present invention can be constructed from a single layer or from multiple layers of materials.

When the wipe pad of the present invention is made from a single layer of material, a first side thereof attaches to the mop head or other cleaning tool handle, while the other second side thereof acts as the cleaning surface. As such, the single layer wipe pad of the invention attaches to the mop head, cleans the floor surface, and absorbs the water or other cleaning liquid used to clean the floor.

The composition of single layer wipe pads according to the present invention consists of 60% to 100% of PLA (Polylactic Acid) or other biopolymers fibers like those commercially available under third-party brands of Ecoflex or Ecovio (by BASF company). These fibers could be mono (single) or bi (double) components in their structure and they are certified biodegradable fibers. If the single layer composition is less than 100% of said fiber, the balance of the layer is made of natural fiber such as pulp or rayon made of wood, bamboo, cotton, flaxseed, sugar cane, or other suitable material. For the wet wipe pad, which is the focus of this invention, the combination of 60% to 70% of biopolymer and balance of 40% to 30% natural fiber is most desirable as it can absorb and hold the liquid better.

For a single layer wipe pad of the invention, the first attachment side thereof is configured with first and second non-looped straight-line strips of fibers (linking ribbon/tape) extending from the first end to the second end of the wipe pad in proximity to the side edges of the wipe pad. The non-looped straight-line linking tapes or ribbons provide a design that is different from the materials with traditional “loops” for allowing the wipe pad to attach to the “hooks” of the Velcro mechanism of the mop head or utility handle. These linking tapes or ribbons are made of grouping in parallel of the filament yarns. The composition of these filament yarns also are made of PLA or other biopolymers (as mentioned in above) in mono or bi component structure. These linking ribbons are connected or attached to the wipe pad with ultrasonic welding method.

When the wipe pad of the present invention is made from multiple layers of material—e.g., from three layers of material—the wipe pad of the present invention includes a first substantially rectangular cleaning pad/layer, a second substantially rectangular attachment pad/layer, and a third substantially rectangular absorption pad/layer disposed between the first pad and the second pad. The attachment pad is configured with a first and second strip of fibers (linking ribbon/tape) extending from the first end to the second end of the attachment pad. The cleaning pad attaches to the attachment pad by ultrasound. The first strip of fibers and the second strip of fibers attach to the attachment pad by ultrasound such that several attachment segments are formed within both strips of fibers.

In multi-layer wipe pads according to the invention, the cleaning pad/layer and the attachment pad/layer are formed from a composition similar to the single layer wipe pad; i.e., from a composition that consists of 60% to 100% of PLA (Polylactic Acid) or other biopolymer fibers like those commercially available under third-party brands of Ecoflex or Ecovio (by BASF company). These fibers could be mono (single) or bi (double) components in their structure and they are certified biodegradable fibers. If the composition of the cleaning pad or the attachment pad is less than 100% of said fiber, the balance of the layer is made of natural fiber such as pulp or rayon made of wood, bamboo, cotton, flaxseed, sugar cane, or other suitable material. For the wet wipe pad of this invention, the combination of 60% to 70% of biopolymer and balance of 40% to 30% natural fiber is most desirable as it can absorb and hold the liquid better.

The third absorption pad is formed from 100% natural pulp or viscose fiber (e.g., wood or bamboo) or other suitable natural compostable and biodegradable absorption material with a variety of possible weights and thicknesses but narrower in width as compared to the first cleaning and second attachment pad layers. The narrower width of third/middle absorption pad will allow other attachment and cleaning layers to come into touch with each other in order to use ultrasonic welding to fuse all of them together.

Each of the first pad, the second pad and the third pad may include at least one embossed portion.

It is also possible to construct the present invention with only two layers: a first cleaning layer and a second attachment layer (similar to those parts described above with respect to the three-layer wipe pad) which ultrasonically attach together. Linking tapes or ribbons would also be used in the same manner and ultrasonically attached to the second attachment layer to allow for the two-layer wipe pad to attach to the Velcro mechanism of the mop head or other cleaning tool handle.

Regardless of whether the wipe pad of the invention is made of a single layer or multiple layers, once the linking ribbons/tapes attach to either the single or to the multiple layers, the final wipe pad product can be used as a wet wipe pad which absorbs liquid and can easily be attached to a mop head or other cleaning utility handle with Velcro mechanism and function properly. Once the cleaning work is accomplished, the wipe pad of the invention is removed easily from the mop head or other cleaning tool and the wipe pad can become compost or biodegrade.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a bottom plan view of a prior art mop head.

FIG. 2 is a top plan view of a prior art wipe pad.

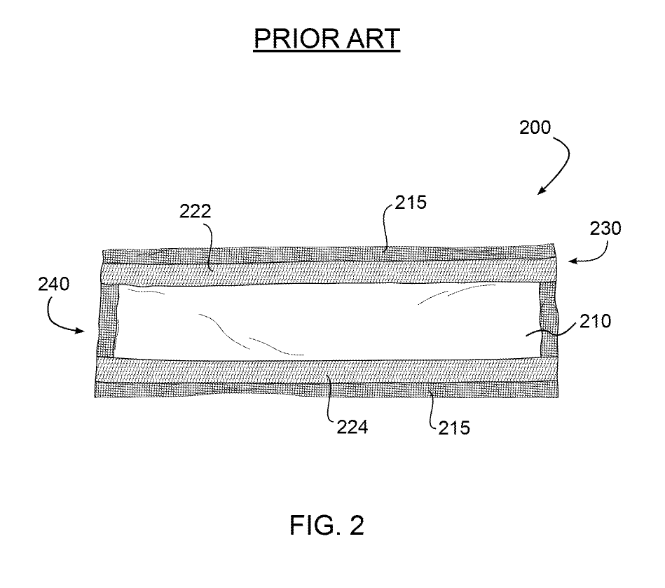

FIG. 3 is a front plan view of a cleaning layer of an embodiment of the wipe pad of the present invention.

FIG. 4 is front plan perspective view of an attachment layer of an embodiment of the wipe pad of the present invention.

FIG. 5 is a side plan view of an embodiment a wipe pad of the present invention taken along line 5-5 of FIG. 4.

FIG. 6 is a front perspective view of an embodiment a wipe pad in accordance with the present invention.

FIG. 7 is a front plan view of an embodiment of a cleaning layer of a wipe pad in accordance with the present invention.

FIG. 8 is a front plan view of an embodiment of an attachment layer of a wipe pad in accordance with the present invention.

FIG. 9 is a front plan view of a wipe pad of the present invention wherein a cleaning layer is partially pulled away from an attachment layer to expose an absorption layer.

### DETAILED DESCRIPTION OF THE INVENTION

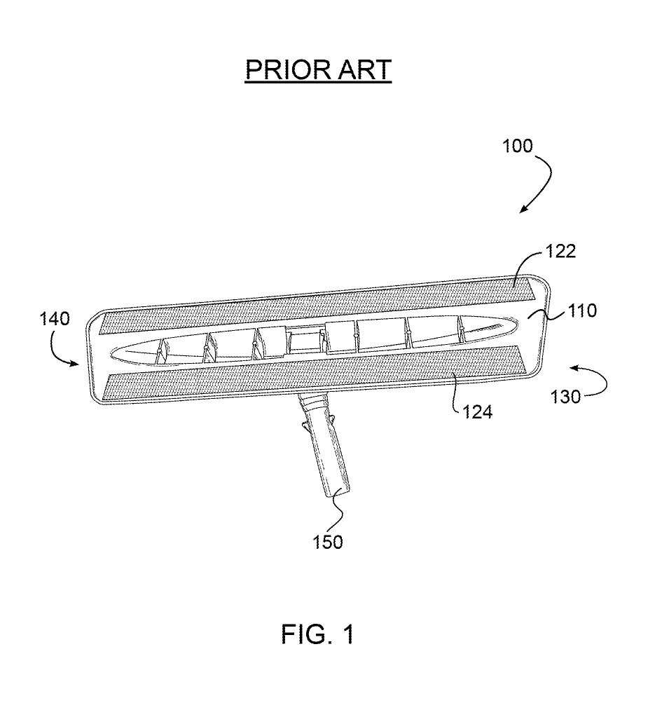

As shown in the drawings for purposes of illustration, the present invention is directed to a cleaning device. The wet wipe pad of the present invention is designed to be connected or attached to floor mop heads or other cleaning tool with a handle that utilize a hook-and-loop mechanism for attaching the wipe pad to the mop head or cleaning tool, such as the existing mop head shown in FIG. 1.

The wipe pad of the invention can be constructed of a single layer or multiple layers of material. For a wipe pad made of a single layer, a first side thereof attaches to the mop head or other cleaning tool handle, and its second side acts as the cleaning surface. The attachment side is configured with at least one linking ribbon/tape formed of non-looped straight-line strip of fibers extending along the length of the layer, providing the means or mechanism for releasably securing to the “hooks” disposed on the mop head. As such, the single layer wipe pad of the invention attaches to the mop head, cleans the floor surface, and absorbs the water or other cleaning liquid used to clean the floor.

For a wipe pad of the present invention made of multiple layers—e.g., from three layers of material—the wipe pad includes a first cleaning layer (sheet or pad) ultrasonically welded to a second attachment layer (sheet or pad) having a third absorption layer (sheet or pad) disposed between the cleaning layer and the attachment layer. The attachment layer is configured with at least one linking ribbon/tape formed of non-looped straight-line strip of fibers extending along the length of the layer for being releasably secured to “hooks” disposed on the mop head.

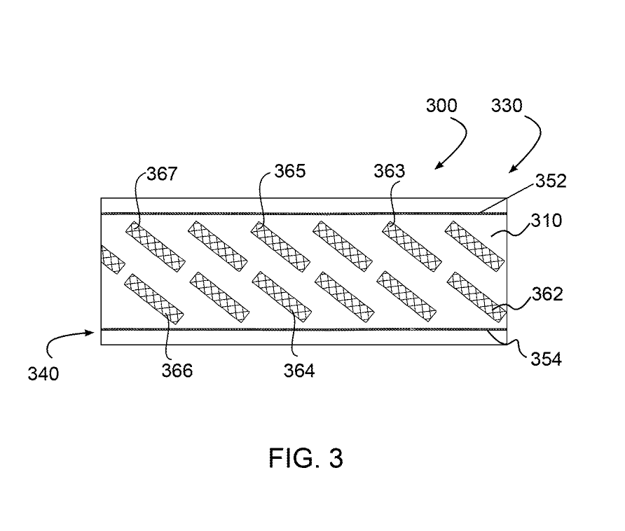

Turning now to the drawings, in which like reference numerals represent like or corresponding aspects of the drawings and with particular reference to FIGS. 3 to 5, the wipe pad of the present invention can be constructed of a single layer or multiple layers of material.

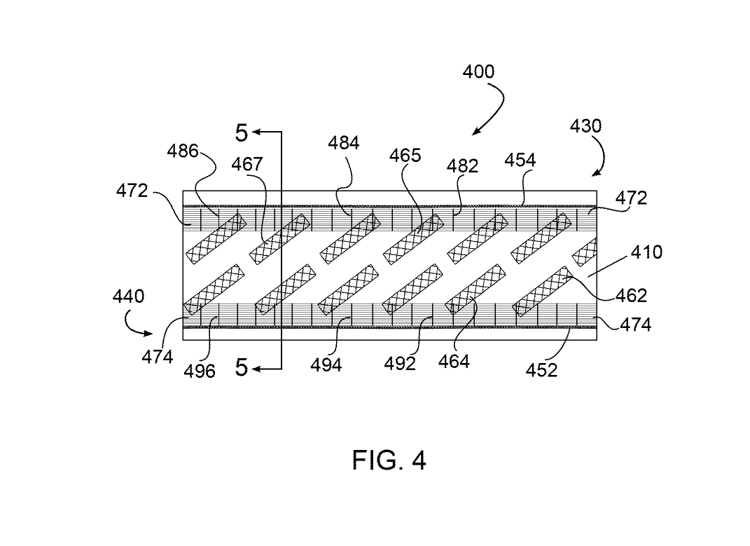

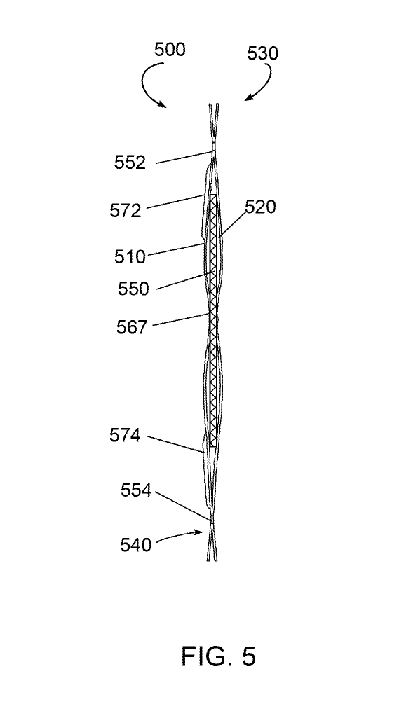

For a multiple layer construction of the wipe pad of the invention—e.g., a three layer wipe pad—the wipe pad includes a first cleaning layer/sheet/pad/surface 310 (FIG. 3), a second attachment layer/sheet/pad/surface 410 (FIG. 4) and a third absorption layer/sheet/pad 550 (FIG. 5) disposed between the other two layers or surfaces. As shown in FIG. 3, and by way of example, the cleaning pad 300 includes a cleaning surface 310 extending from a first (right) end 330 to a second (left) end 340 of the pad. The cleaning pad is shown with a first (top) ultrasound (pressed) junction 352 and a second (bottom) ultrasound junction 354 resulting from the process of securing the cleaning pad to the attachment pad (see FIG. 5). The ultrasound pressed junctions may be linear or have other shapes adequate for securing the two layers. Furthermore, the junctions need not be contiguous; however, a continuous linear weld adds strength and rigidity to the assembled wipe pad.

For a single layer wipe pad of the invention, it would be constructed only of a single layer of material 400 (FIG. 4) with one side thereof being an attachment surface 410 (FIG. 4) attaching to the mop head and its opposite side acting as a cleaning surface. In such embodiment, a separate cleaning pad/layer 300 as shown in FIG. 3 and an absorption layer 550 as shown in FIG. 5 would not be utilized.

Continuing to describe a multiple layer wipe pad of the invention, as shown in FIG. 3, the cleaning surface 310 of the cleaning pad 300 may also include multiple embossed areas 362, 363, 364, 365, 366 (shown in diagonally placed positions) formed by use of known press mechanism to provide for additional connectivity of the various layers of the wipe pad together. The embossed portions may include a logo, text or other symbols for product identification such as a trademark, brand name or company name. The embossed areas may provide additional strength and rigidity to the assembled wipe pad.

Referring now to FIG. 4, and by way of example, the attachment pad or layer 400 includes a middle surface 410 extending from a first (right) end 430 to a second (left) end 440 of the pad. The attachment pad is shown with a first (top) ultrasound (pressed) junction 452 and a second (bottom) ultrasound junction 454 resulting from the process of securing the cleaning pad 300 to the attachment pad (see FIG. 5). The surface of the attachment pad may include multiple embossed areas 462, 464, 465, 464 (shown in diagonally placed positions corresponding to those shown in FIG. 3) formed by pressing mechanism.

The cleaning layer 300, 520 of the wipe pad 500 may be formed from a combination of materials that enables the wipe pad to act as a wet wipe and absorb liquid when the wipe pad touches a floor or other surface to be cleaned. The material of the cleaning layer and of the attachment layer 400 is selected to enable each of those layers to attach to other layers of the wipe pad with ultrasound equipment. In accordance with the present invention, the cleaning pad/layer 300, 520 and the attachment pad/layer 400, 510 are formed from compostable/biodegradable materials, and more specifically from a composition that consists of 60% to 100% of PLA (Polylactic Acid) or other biopolymer fibers like those commercially available under third-party brands of Ecoflex or Ecovio (by BASF company). These fibers could be mono (single) or bi (double) components in their structure and they are certified biodegradable fibers. If the composition of the cleaning pad or the attachment pad is less than 100% of said fiber, the balance of the layer is made of natural fiber such as pulp or rayon made of wood, bamboo, cotton, flaxseed, sugar cane, or other suitable material. For the wet wipe pad of the invention, the combination of 60% to 70% of biopolymer and balance of 40% to 30% natural fiber is most desirable as it can absorb and hold the liquid better. Alternative and suitable materials for absorption in the cleaning pad may include products that provide adequate absorption of liquids while achieving the objectives of the present invention to provide economical, relatively lightweight easy to manufacture, responsive to an ultrasound manufacturing process, and compostable and biodegradable wipe pads.

With further reference to FIG. 4, at least one linking ribbon or tape 472, 474 is secured to the attachment layer 400 of the wipe pad 500. As shown, a pair of linking ribbons/tapes is configured along the longitudinal edges (upper and lower) to allow the wipe pad to be attached to the ‘hook’ mechanism that is part of existing mop heads (FIG. 1). Each linking ribbon is made of a grouping in non-looped parallel lines of filament yarns that are made of PLA (Polylactic Acid) or other biopolymers in mono or bi component structure. Each linking ribbon or tape is configured with segmented loops for connection with the hooks that are typically provided on the attachment strip(s) positioned on the mop head.

In distinction from other existing wipe pads, the linking ribbon of the present invention does not connect to the body of the wipe pad by glue or sewing/stitching, and instead is secured to the body of the pad by use of ultrasound technique and equipment. Moreover, each linking ribbon is made of very thin and fine non-looped parallel threads to create the most and best effective connection with the strip of attachment “hooks” on the mop head. A wave-like pattern of segmented linking ribbon/tape is formed using multiple ultrasound pressed area lines 482, 484, 486, 492, 494, 496. In this unique manner of construction and assembly, when the linking ribbon and wipe pad of the present invention come into contact with liquid (e.g., water or other cleaning solution) and become wet, the connection between the segmented linking tape on the wipe pad and the strip of attachment “hooks” on the mop head holds well such that the wipe pad does not unexpectedly come apart from the mop head. Therefore, unlike other existing wipe pads, the design and construction of the present invention allows the wipe pad to remain more securely attached to the mop head in wet applications.

As shown in FIG. 5, the assembled wipe pad 500 of the present invention includes a pair of ultrasound pressed lines 552, 554 along the two longitudinal edges 530, 540 of the pad for connecting the cleaning layer 520 to the attachment layer 510. There can be at least one pressed embossed area 567 positioned at intervals along the length of the wipe pad. Two linking tapes/ribbons 572 & 574 are shown in cross section proximate the edges of the attachment layer. An absorption layer (pad, sheet) 550 is disposed between the cleaning layer and the attachment layer. The absorption pad may be formed from fully compostable and biodegradable material such as 100% natural pulp or fiber (e.g., wood, bamboo) with a variety of weight and thicknesses to hold water or other cleaning liquid formulas. The width of the absorption pad/layer is narrower as compared to the width of the first cleaning and the second attachment pad layers, and this will allow the cleaning and attachment layers to meet each other in order to use ultrasonic welding to fuse all of them together. Alternative materials suitable for the absorption pad include products that provide adequate absorption of liquids while achieving the objectives of the present invention to provide economical, relatively lightweight and easy to manufacture, compostable and biodegradable wipe pads.

In one embodiment of the present invention and by way of example only, the wipe pad weighs fourteen grams. In such an example, the pad is thirteen centimeters (cm) wide by forty cm long (approximately five inches by sixteen inches). The thickness of that wipe pad is 1.5 millimeters (mm), and the linking ribbon is two cm wide. In accordance with the present invention, however, the wipe pad may be made in various sizes, shapes to accommodate a particular mop head and its intended use.

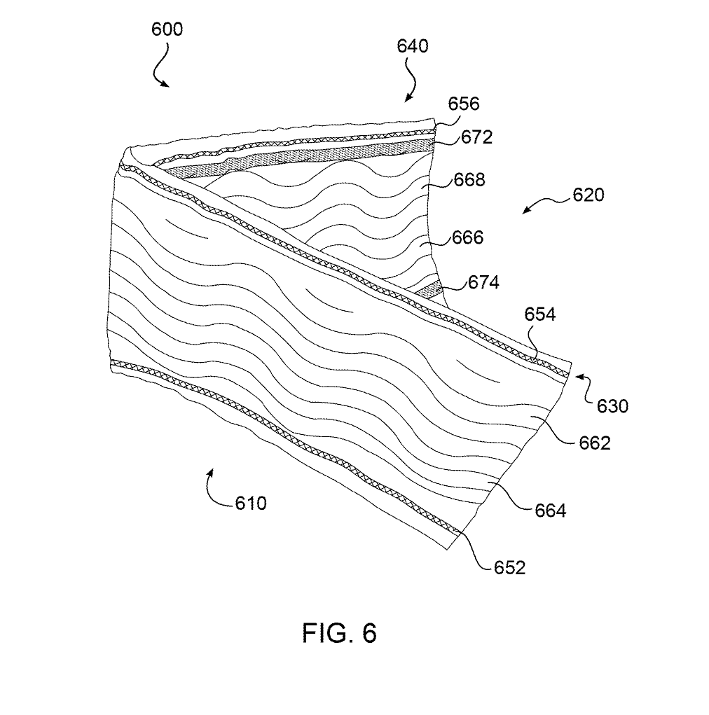

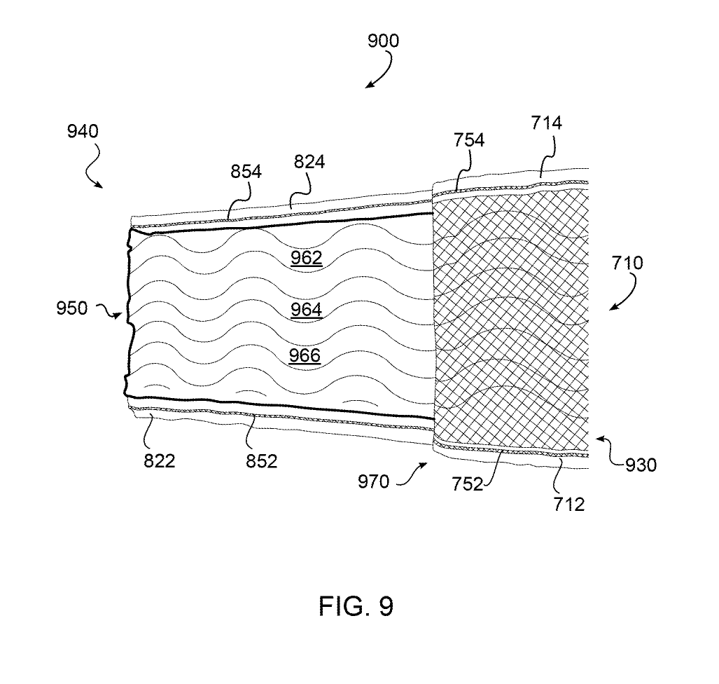

Referring now to FIG. 6, the multi-ply wipe pad of the present invention is shown fully assembled and having a structural rigidity to stand on its edges when folded or bent. This wipe pad 600 is similar to that depicted in FIGS. 3-5, but is shown in perspective for clarity of understanding the relationship of the portions of the invention. For example, the assembled wipe pad includes a pair of ultrasound pressed lines 652, 654 along the two longitudinal edges of the cleaning pad 610. Also shown is the first ultrasound pressed line 656 on the attachment layer 620 that extends from the first (right) end 630 to the second (left) end of the wipe pad 640 and corresponds to the second (upper) ultrasound pressed line 654 on the cleaning pad. The attachment pad is shown with two linking strips 672 and 674 for releasably connecting to the “hook” portions of a mop head (FIG. 1). In FIG. 6, multiple embossed areas 662, 664, 666 and 668 are curved (or as a cosmetic feature without affecting the structural design or functional purpose, they can be the rectangular shaped embossed areas that are shown in FIGS. 3 and 4) and are pressed through both the cleaning pad and the attachment pad to provide structural integrity with the adapter assembly pad (FIG. 9).

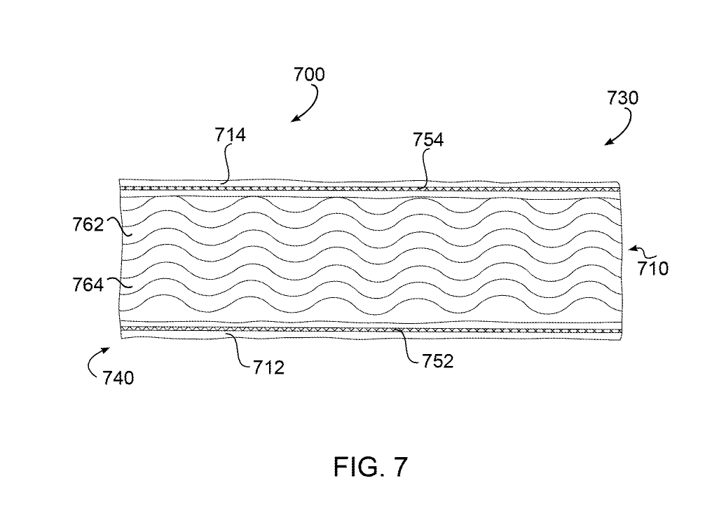

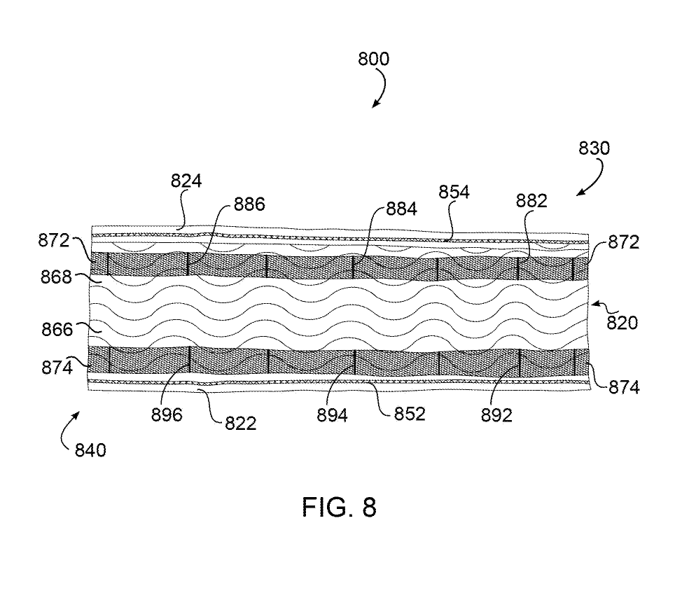

With reference to the assembled multi-ply wipe pad of the invention that is shown in FIG. 6 in assembled form, FIG. 7 separately shows the cleaning layer thereof, and FIG. 8 separately shows the attachment layer of the multi-ply wipe pad. FIG. 9 shows the multi-ply wipe pad 900 of the present invention that includes the cleaning layer 700 of FIG. 7 ultrasonically welded to an attachment layer 800 of FIG. 8 having an absorption layer 950 disposed between the cleaning layer and the attachment layer. The assembled wipe pad includes a first (lower) ultrasound pressed line 752, 852 along the lower longitudinal edge 712 of the cleaning pad and the lower edge 822 of the attachment layer. The assembled wipe pad further includes a second (upper) ultrasound pressed line 754, 854 along the upper longitudinal edge 714 of the cleaning pad and the upper edge 824 of the attachment layer. The ultrasound weld lines on the cleaning layer extend from the first (right) end 730, 830, 930 to the second (left) end 740, 840, 940 of the wipe pad and correspond to the second (upper) ultrasound weld line 654 on the cleaning pad. In this embodiment, multiple press-embossed areas are curved (but could be in other patterns, shapes or formats without affecting the structural design or functional purpose) and are pressed through each of the cleaning layer 762, 764; absorption pad 962, 964, 966; and the attachment layer 866, 868 to provide structural integrity within the wipe pad. The embossed portions may include a logo, text or other symbols for product identification such as a trademark, brand name or company name.

The attachment layer 800 is configured with at least one strip of linking fibers (threads) 872, 874 extending along the longitudinal length of the layer (see FIG. 8). The strips of fibers may be formed from polypropylene or other suitable material, wherein a ribbon (tape) may be disposed on a roll (spool) such that the fibers are positioned along the longitudinal length of the attachment pad. The linking fibers are secured to the attachment pad and segmented by ultrasound formed vertical (perpendicular to the longitudinal length) lines 882, 884,886, 892, 894, 896 in the two sets of linking strips, thereby forming ‘waves’ in the fibers. The ultrasound areas in the linking strip secure the fibers to the middle portion 820 of the attachment layer. The linking fiber strips on the attachment layer extend from the first (right) end 730, 830, 930 to the second (left) end 740, 840, 940 of the wipe pad and are proximate the lower edge 822 and the upper edge 824. The segmented strips of fiber securely (but releasably) fasten to the portions of a mop head having ‘hook’ strips or otherwise formed segment (see FIG. 1).

Those skilled in the art of manufacturing mechanical devices such as the disclosed cleaning device can determine, without undue experimentation, the appropriate dimensions, geometries, materials, and other features of the wipe pad. Other embodiments in accordance with the present invention (for example, but not limited to, use with various mop heads or a hand-held apparatus) may be employed as is known to those skilled in the art of designing and/or manufacturing of cleaning devices. Similarly, those skilled in the art will understand from the disclosure herein that various modifications to the components (cleaning layer, attachment layer, absorption pad and linking ribbon or fibers) of the wipe pad can be made without departing from the scope of the invention. More specifically, the present invention is not limited to any particular method of forming (manufacturing) the wipe pad and it components.

While certain aspects of the invention have been illustrated and described herein in terms of its use as a wipe pad for use with a mop head, modifications and improvements to the disclosed apparatus may be made without departing from the scope of the invention. Accordingly, the scope of the invention is not intended to be limited by, for example, but not limited to, the details of the drawings and the appended claims.

I claim:

1. A cleaning wet wipe pad, comprising:
a first substantially rectangular cleaning pad layer having a first end, a second end and a middle portion formed between the first end and the second end;
a second substantially rectangular attachment pad layer having a first end, a second end and a middle portion formed between the first end and the second end, wherein the middle portion of the second pad layer is configured with first and second non-looped, straight-line strips of fibers extending from the first end to the second end; and
a third substantially rectangular absorption pad layer disposed between the first pad layer and the second pad layer;
wherein the first, second and third pad layers are made of 100% compostable and biodegradable materials.

2. The cleaning wet wipe pad of claim 1, wherein the first and second pad layers are formed from a composition that consists of 60% to 100% biopolymer materials.

3. The cleaning wet wipe pad of claim 1, wherein the first and second pad layers are formed from a composition that consists of 60% to 100% Polylactic Acid (PLA) materials.

4. The cleaning wet wipe pad of claim 1, wherein the first and second pad layers are formed from a composition that consists of 60% to 70% biopolymer materials and the balance of 40% to 30% natural fiber materials.

5. The cleaning wet wipe pad of claim 1, wherein the third absorption layer is formed from a composition that consists of 100% natural pulp materials.

6. The cleaning wet wipe pad of claim 1, wherein the third absorption layer is formed from a composition that consists of 100% viscose fiber materials.

7. The cleaning wet wipe pad of claim 1, wherein the first and second non-looped, straight-line strips of fibers are attached to the second pad layer by ultrasound.

8. The cleaning wet wipe pad of claim 1, wherein the first pad layer and the second pad layer are attached to one another by ultrasound.

9. A cleaning wet wipe pad, comprising:
a first substantially rectangular cleaning pad layer having a first end, a second end and a middle portion formed between the first end and the second end; and
a second substantially rectangular attachment pad layer having a first end, a second end and a middle portion formed between the first end and the second end, wherein the middle portion of the second pad layer is configured with first and second non-looped, straight-line strips of fibers extending from the first end to the second end;
wherein the first and second pad layers are made of 100% compostable and biodegradable materials.

10. The cleaning wet wipe pad of claim 9, wherein the first and second pad layers are formed from a composition that consists of 60% to 100% biopolymer materials.
